(19) United States
(12) Patent Application Publication
(10) Pub. No.: US 2015/0261079 A1
(43) Pub. Date: Sep. 17, 2015

(54) LIGHT ABSORBING FILM, REFLECTION-TYPE SCREEN FOR FRONT PROJECTION DISPLAY DEVICE HAVING THE SAME, AND METHOD FOR MANUFACTURING LIGHT ABSORBING FILM

(71) Applicant: SAMSUNG ELECTRONICS CO., LTD., Suwon-si (KR)

(72) Inventors: Wook-jae JEON, Hwaseong-si (KR); Jean HUR, Seongnam-si (KR); Sang-hyun SOHN, Suwon-si (KR)

(73) Assignee: SAMSUNG ELECTRONICS CO., LTD., Suwon-si (KR)

(21) Appl. No.: 14/510,656

(22) Filed: Oct. 9, 2014

(30) Foreign Application Priority Data
Mar. 14, 2014 (KR) 10-2014-0030139

(51) Int. Cl. G03B 21/60; G02B 5/22; B32B 37/14; G02B 5/20

(52) U.S. Cl. CPC G03B 21/60; G02B 5/201; G02B 5/22; B32B 37/144; B32B 2255/00

(57) ABSTRACT

A method for manufacturing a light-absorbing film is provided, where the light-absorbing film absorbs external light incident on a reflection surface of a reflection-type screen. The method includes forming a dye layer by spreading dye, including a light absorbing material, on a surface of a first transparent film, laminating a second transparent film on the dye layer, forming a cylindrical film roll by winding the first and second transparent films, laminated on the dye layer, around a core, and forming a film member by slicing the film roll along a direction that is inclined with respect to a radial direction of the film roll.

### PRIORITY

This application claims priority under 35 U.S.C. §119(a) to Korean Patent Application No. 10-2014-0030139 filed on Mar. 14, 2014, in the Korean Intellectual Property Office, the disclosure of which is incorporated herein by reference.

### BACKGROUND OF THE INVENTION

1. Field

Apparatuses and methods consistent with exemplary embodiments relate to a light absorbing film, a reflection-type screen for a front projection display device having the same, and a method for manufacturing a light absorbing film, and more particularly to a light absorbing film that is arranged on a reflection surface of a reflection layer of a reflection-type screen, the reflection-type screen for a front projection display device having the same, and a method for manufacturing a light absorbing film.

2. Description of the Related Art

Typically, a front-type reflective screen that is applied to a projection display device is used to improve the brightness of the screen.

However, if the viewing environment is a bright room, the black on the screen becomes increasingly bright due to the surrounding external light, and the contrast of the screen deteriorates.

To solve this problem, in the related art, a film that absorbs external light, to secure clear picture quality, is attached to the reflection layer of the screen. This film forms a plurality of louver black stripe layers horizontally arranged in a thickness direction in which the external light surrounding the screen is absorbed.

However, the film of the related art includes an external light absorbing layer having louver black stripe layers arranged in the horizontal direction, and if the film is applied to a short projection system, surrounding external light, particularly, external light incident from the left and right sides side of the screen and external light that is incident from above an upper portion of the left and right sides of the screen, are not properly blocked.

In addition, if image light is incident to the screen at a large angle, it is absorbed into the louver black stripe layers that are horizontally arranged, and thus a loss of brightness occurs which deteriorates the contrast.

### SUMMARY

One or more exemplary embodiments described herein may address at least the above problems and/or disadvantages and provide at least the advantages described below. Accordingly, one or more exemplary embodiments may provide a light absorbing film, which can obtain high bright room contrast through effective absorption of external light incident on a reflection-type screen and maximum reflection of image light to a viewer side, the reflection-type screen for a front projection display device having the same, and a method for manufacturing a light absorbing film.

According to an aspect of an exemplary embodiment, a method for manufacturing a light absorbing film that absorbs external light incident on a reflection surface of a reflection-type screen, includes forming a dye layer by spreading dyes, including a light absorbing material, on one surface of a first transparent film; laminating a second transparent film on the dye layer; forming a cylindrical film roll by winding the first and second laminated films around a core; and forming a film member by slicing the film roll in a direction that is inclined with respect to a radial direction of the film roll.

The core may be cylindrical.

A start position of slicing of the film roll may correspond to a chord that passes through a center of a one cross-sectional surface of the film roll. The method may further include cutting the film member in a shape that corresponds to a shape of the screen.

One side of the film member corresponding to the start position of the slicing may correspond to a lower end of the screen.

The core may be an elliptic cylinder.

A start position of the slicing of the film roll may correspond to a long axis of one cross-sectional surface of the film roll. The method may further include cutting the film member in a shape that corresponds to a shape of the screen.

The film member may include a plurality of tinted portions and a plurality of light transmission portions that are inclined downward with respect to a thickness direction of the film member.

The plurality of tinted portions and the plurality of light transmission portions may be alternately laminated. In this case, the plurality of tinted portions and the plurality of light transmission portions may be arranged in a concentric pattern along a surface direction of the light absorbing film.

The dyes may have a concentration with a predetermined transmission rate. In this case, the dyes may be black.

According to an aspect of another exemplary embodiment, a light absorbing film includes a plurality of tinted portions inclined downward with respect to a thickness direction of the film; and a plurality of light transmission portions alternately laminated between the plurality of tinted portions, wherein the plurality of tinted portions and the plurality of light transmission portions are arranged in a concentric pattern along a surface direction of the film. In this case, a reflection-type screen may include a light absorbing film as described above and a reflection layer having a front surface to which the light absorbing film is attached.

### BRIEF DESCRIPTION OF THE DRAWINGS

The above and/or other exemplary aspects, features and advantages will be more apparent from the following detailed description when taken in conjunction with the accompanying drawings, in which:

FIG. 1 is a schematic view illustrating that image light is projected onto a front-type reflective screen having a light absorbing film through a beam projector according to a first exemplary embodiment;

FIG. 2 is an enlarged cross-sectional view illustrating a portion II shown in FIG. 1;

FIG. 3 is a view illustrating a light absorbing film as seen from the front surface of the screen illustrated in FIG. 1;

FIGS. 4A-4C, 5A-5B, 6A-6B, 7, and 8 are views explaining a process of manufacturing a light absorbing film according the first exemplary embodiment;

FIG. 9 is a flowchart illustrating a process of manufacturing a light absorbing film according to according to the first exemplary embodiment;

FIGS. 10 to 13 are views explaining a process of manufacturing a light absorbing film according to a second exemplary embodiment;

FIGS. 14 to 16 are views explaining a process of manufacturing a light absorbing film according to a third exemplary embodiment; and

FIG. 17 is a view explaining a state where an external light is absorbed in a light absorbing film according to the third exemplary embodiment.

### DETAILED DESCRIPTION

Hereinafter, first to third exemplary embodiments are described in detail with reference to the accompanying drawings.

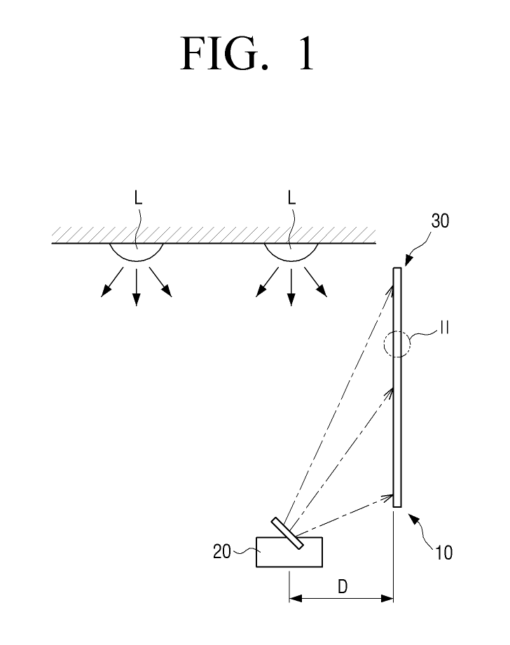

Referring to FIG. 1, a front projection display device 10 according to a first exemplary embodiment may include a projector 20 and a reflection-type screen 30.

The projector 20 is a short length or an ultimate short length projection system 20 having a considerably short distance D between the projector 20 and the reflection-type screen 30 in comparison to typical projectors. The projector 20 is arranged on a lower side of a front portion of the reflection-type screen 30 to project an image (moving image or still image) toward the reflection-type screen 30.

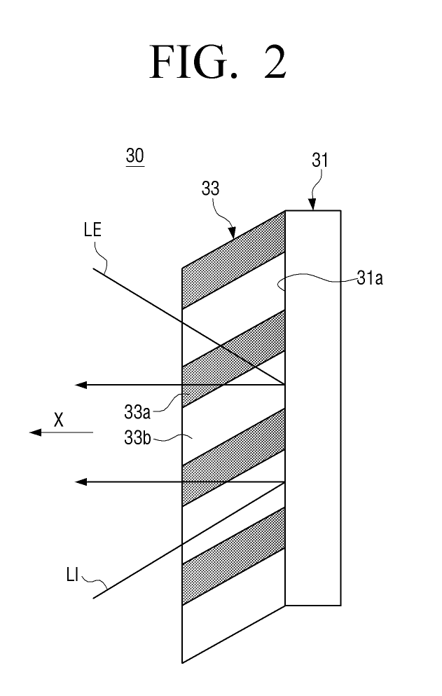

The reflection-type screen 30 may include a reflection layer 31 and a light absorbing film 33, as shown in FIG. 2. The reflection-type screen 30 may be a front-type reflective screen for a short length or an ultimate short length projection display device.

The reflection layer 31 reflects image light that is incident from the projector 20 (see FIG. 1) toward the front of the screen. For this, a reflection material (e.g., silver or aluminum) may be coated on a front surface 31a of the reflection layer 31. Further, it is also possible that the reflection layer 31 may be formed as a typical Fresnel mirror-type layer.

Referring to FIG. 2, the light absorbing film 33 is arranged on the reflection surface 31a of the reflection layer 31. The light absorbing film 33 includes a plurality of tinted portions 33a and a plurality of light transmission portions 33b. In this case, the plurality of tinted portions and the plurality of light transmission portion 33b may be alternately laminated.

The plurality of tinted portions 33a may be formed of dyes having including a black color having light absorbing particles to block the external light. In this case, the plurality of tinted portions 33a may be arranged between the plurality of light transmission portions 33b, and in order to improve a mutual bonding force between the plurality of light transmission portions 33b that are adjacent to each other, the dyes may include adhesive components. The plurality of tinted portions 33a serve to block the external light incident on the reflection-type screen 30 to contribute to the improvement of contrast of an image.

Further, the plurality of tinted portions 33a have a predetermined transmission rate so that they do not completely block the image light that is reflected from the reflection layer 31. Accordingly, the concentration of the dyes that form the tinted portion 33a are determined in consideration of the transmission rate. In this case, the plurality of tinted portions 33a may be formed to have a refraction index that is higher than the refraction index of the plurality of light transmission portions 33b.

The plurality of light transmission portions 33b may be manufactured in a film shape that is made of a transparent polymer resin that does not have light absorbing particles.

As described above, the tinted portions 33a and the light transmission portions 33b are arranged to be inclined downward at a predetermined angle in the thickness direction of the light absorbing film 33, and may be arranged to be inclined downward in a direction toward the projector 20 that projects the image light. In this case, the respective tinted portions 33a may be arranged at the same angle.

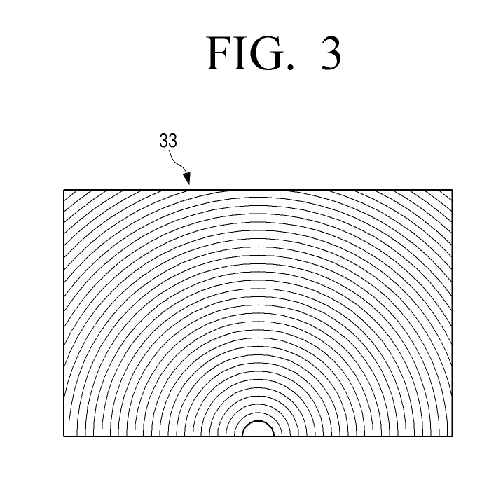

Referring to FIG. 3, as the light absorbing film 33 is seen from the side of the screen on which the projector 20 is located (e.g. the front side of the screen), the plurality of tinted portions and the plurality of light transmission portions 33b are arranged in a concentric pattern along a surface direction of the light absorbing film 33.

As described above, since the reflection-type screen 30 includes the light absorbing film 33, as illustrated in FIG. 2, an external light LE that is emitted from the upper side and left and right sides of the reflection-type screen 30 passes through the light absorbing film 33 at least once before reaching the reflection layer 31, and then passes through the light absorbing film 33 at least once after being reflected by the reflection layer 31, whereas the image light LI passes through the light absorbing film 33 only once after being reflected by the reflection layer 31.

That is, the external light LE that is incident toward the reflection-type screen 30 travels toward a viewer after passing through the light absorbing film 33 at least twice, whereas the image light LI that is projected toward the reflection-type screen 30 travels toward the viewer in a direction of an arrow X after passing through the light absorbing film 33 only once.

Accordingly, the reflection-type screen 30 may maintain high performance by blocking the external light with the light absorbing film 33 and may simultaneously minimize a loss of the image light LI. Further, in comparison to the reflection-type screen in the related art, high video contrast in a bright room can be improved.

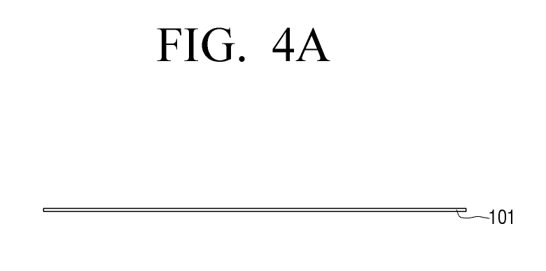

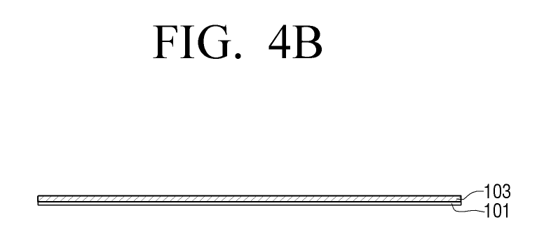

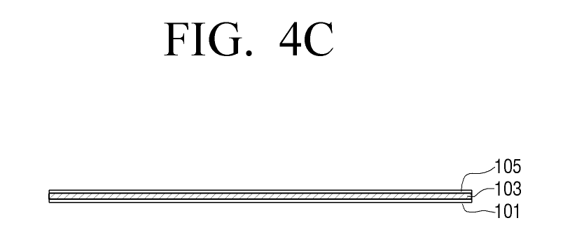

Hereinafter, referring to FIGS. 4A to 9, a process of manufacturing the light absorbing film 33 will be successively described.

First, a first transparent film 101 having high transmission rate as shown in FIG. 4A is prepared, and dyes that include light absorbing particles as shown in FIG. 4B are spread on one surface of the first film 101 to form a dye layer 103 (S1).

In this case, the dyes may have a deep color, for example, a black color, and are manufactured to have a proper concentration, taking into consideration a desired transmission rate. Further, the dye layer 103 forms the tinted portion 33a of the light absorbing film 33 as described above.

Referring to FIG. 4C, a second transparent film 105 is laminated onto the first film 101 so that one surface of the second transparent film 105 that is made of the same material as the material of the first film 101 comes into contact with the dye layer 103 (S2). In this case, the dye layer 103 has a predetermined viscosity to adhere the second film 105 to the first film 101.

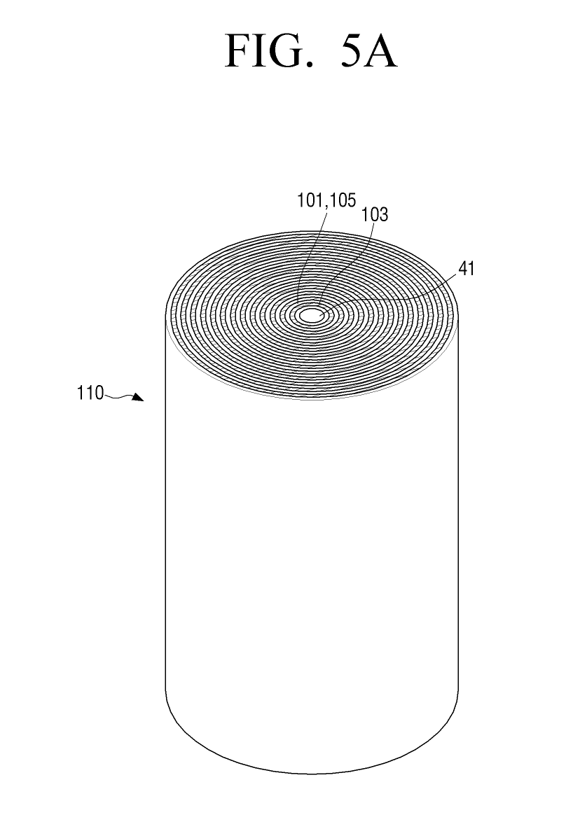

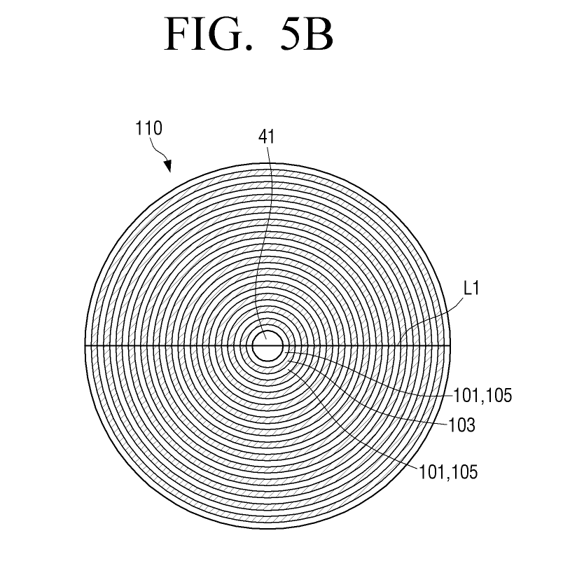

Referring to FIG. 5A, the first and second films 101 and 105, in a laminated state, are wound around the circumference of a cylindrical core 41. In this case, if the first and second films 101 and 105 in the laminated state are wound on the cylindrical core 41 in a state in which, an adhesive tape is attached on side of the first and second films 101 and 105 along the length direction of the cylindrical core 41, a film roll 110 that is in a substantially cylindrical shape is formed (S3).

Referring to FIG. 5B, a cross-sectional surface of the film roll 110 is circular shape, and the first and second transparent films 101 and 105 that transmit the light and the dye layer 103 that absorbs the light are successively laminated.

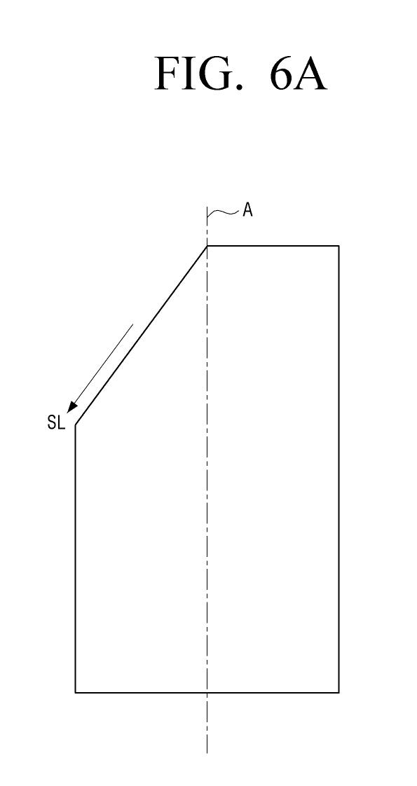

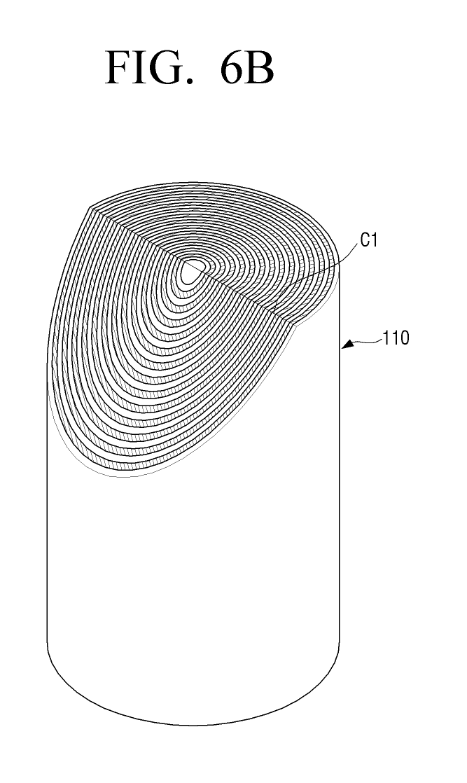

Then, the cylindrical core 41 is separated from the film roll 110, and then as shown in FIGS. 6A and 6B, the film roll 110 is sliced in the direction of an arrow SL in a state in which a predetermined angle is maintained with respect to a center axis A of the film roll 110. In this case, as shown in FIG. 5B, a start position C1 of the slicing may correspond to a chord L1 that passes through a center of the film roll 110.

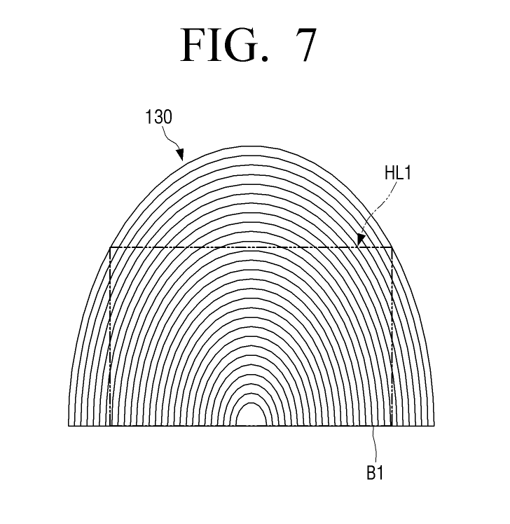

Referring to FIG. 7, a film member 130 having a predetermined thickness is obtained from the film roll 110 by slicing the film roll 110 at the same angle as described above. In this case, the film member 130 may be in a semi-elliptical shape that is cut substantially along a short axis of the elliptical shape.

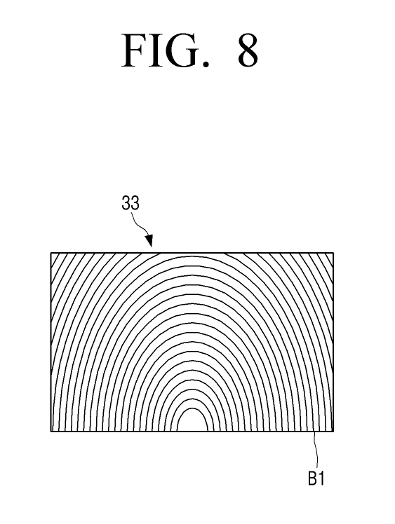

In order to laminate the film member 130 on the reflection layer 31 of the reflection-type screen 30, the film member 130 is cut (S5) along a dashed line HL1 illustrated in FIG. 7 to have a width that corresponds to the size of the reflection-type screen 30, and as shown in FIG. 8, the light absorbing film 33 having a predetermined size is obtained.

When the light absorbing film 33 that is obtained through the above-described process is attached to the reflection surface 31a of the reflection layer 31 of the reflection-type screen 30, the light absorbing film 33 is arranged so that one side B1 thereof (see FIG. 8) corresponding to the start position of the slicing corresponds to a lower end of the reflection-type screen 30.

On the other hand, it is exemplified that the film roll 110a is in a cylindrical shape, but is not limited thereto. It is also possible to manufacture the film roll 110a in an elliptic cylinder shape.

As described above, since the light absorbing film 33 according to the first exemplary embodiment is formed by slicing the cylindrical or elliptic cylindrical film roll 110 in an inclined state, the plurality of tinted portions 33a are arranged to be inclined in the thickness direction of the light absorbing film 33, and are arranged in a concentric pattern substantially from the center portion of the lower ends B1 and B2 of the light absorbing film 33 toward the upper end of the light absorbing film 33.

Since the plurality of tinted portions are formed in the concentric pattern, both the external light that is emitted from the upper side of the reflection-type screen 30 by a ceiling lamp L, and also the external light that is emitted from the left/right side of the screen 30 toward the reflection-type screen 30 can be effectively absorbed to greatly improve the contrast even in a bright room.

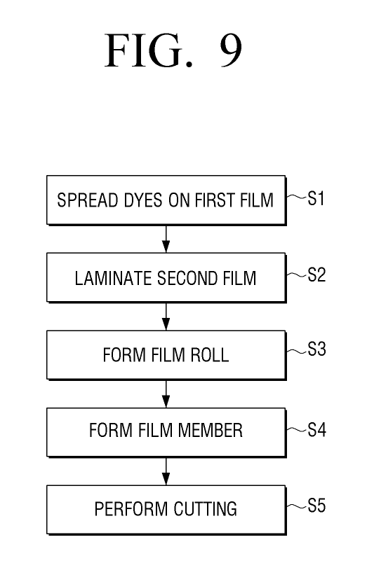

Hereinafter, referring to FIGS. 9 to 13, a method that can obtain a light absorbing film 133 through an elliptical film roll 110a according to a second exemplary embodiment will be described.

A process of arranging and laminating the dye layer 103a between the first and second films 101a and 105a is the same as the process illustrated in FIGS. 4A to 4C.

Then, the film roll 110a having an elliptical cross-sectional surface is formed as shown in FIG. 9 by winding the first and second laminated films 101a and 105a on an elliptic cylindrical core 43.

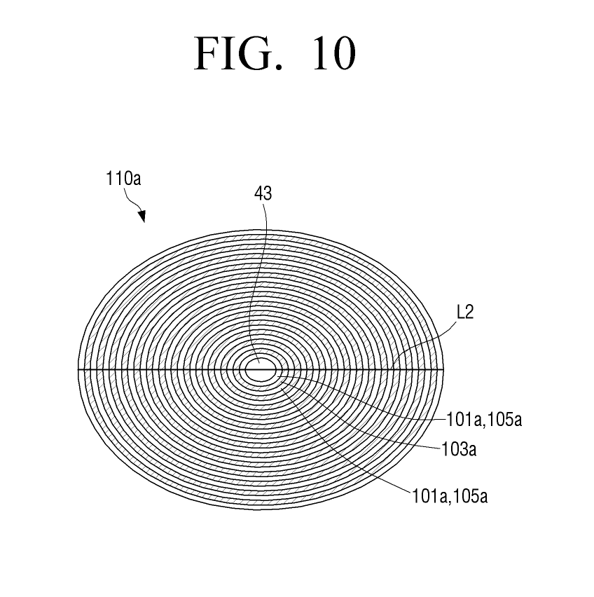

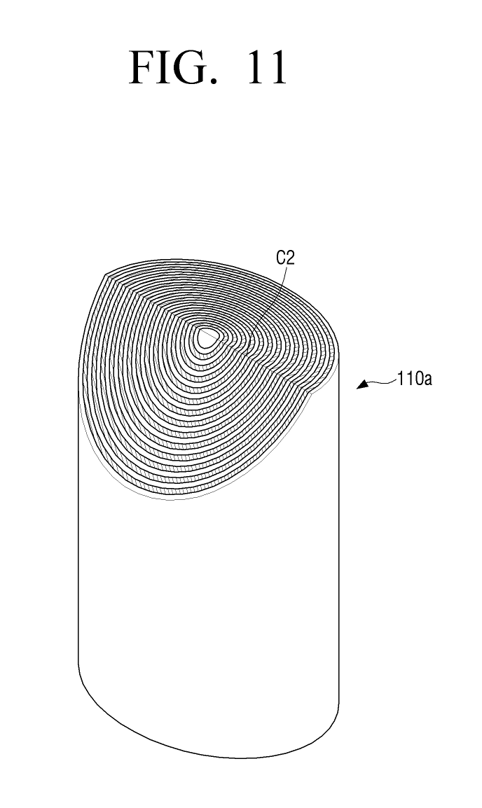

In this case, referring to FIG. 11, a slicing start position C2 of the film roll 110a may correspond to a long axis L2 (see FIG. 10) of an ellipse of the cross-sectional surface.

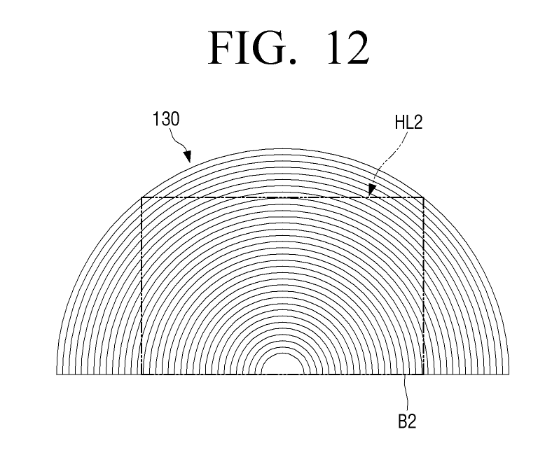

Through the slicing of the film roll 110 as described above, as shown in FIG. 12, a film member 130a having a substantially semi-circular shape can be obtained. The overall shape of the film member 130a may differ somewhat depending on the slicing angle of the film roll 110a.

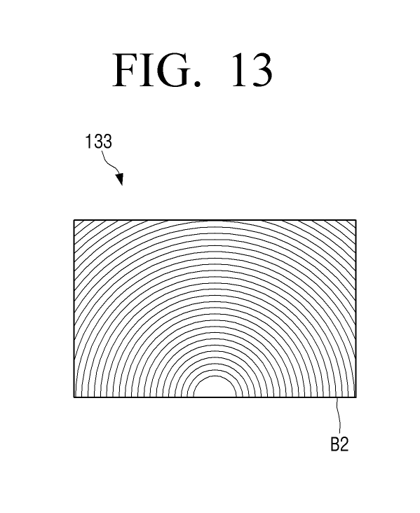

The film member 130a is cut along a set dashed line HL2 (see FIG. 12) in consideration of the size of the reflection-type screen 30 to obtain the final light absorbing film 133 as shown in FIG. 13.

In a similar manner as with respect to the light absorbing film 33 as illustrated in FIG. 8, the light absorbing film 133 includes a plurality of tinted portions 33a and a plurality of light transmission portions 33b which are alternately formed in a concentric pattern, and the concentric circle has a curvature that is substantially close to a normal circle.

In the same manner as with respect to the above-described light absorbing film 33, the light absorbing film 133 according to another exemplary embodiment can effectively absorb the external light that is incident from the upper side and the left and right sides of the reflection-type screen 30 when it is applied to the reflection-type screen 30, and thus high bright room contrast can be obtained.

The light absorbing films 33 and 133 adopted in the first and second exemplary embodiments as described above may be used for short length or ultimate short length projectors, and the light absorbing film 233 that is adopted in a third exemplary embodiment to be described hereinafter can be used for a long length projector.

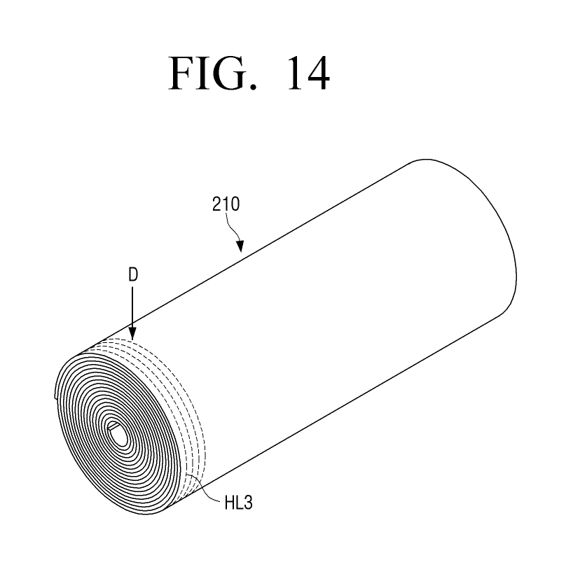

Hereinafter, referring to FIGS. 14 to 16, a method that can obtain a light absorbing film 233 through a cylindrical film roll 210 according to a third exemplary embodiment will be described.

In the same manner as with respect to the first exemplary embodiment, according to the third exemplary embodiment, a cylindrical film roll 210 is formed as shown in FIG. 14 through a process of arranging and laminating a dye layer 103a between the first and second films 101a and 105a (see FIGS. 4A to 4C).

Then, the cylindrical film roll 210 is sliced along a dashed line HL3 in a direction (direction of an arrow D) that is substantially perpendicular to the length direction of the film roll 210.

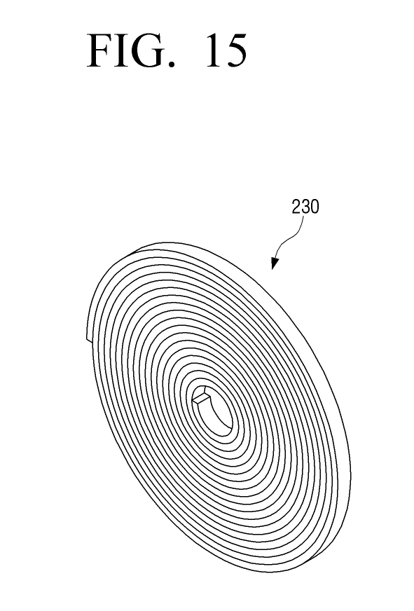

If the film roll 210 is sliced, as shown in FIG. 15, a film member 230 of a thin circular plate shape having substantially the same thickness can be obtained.

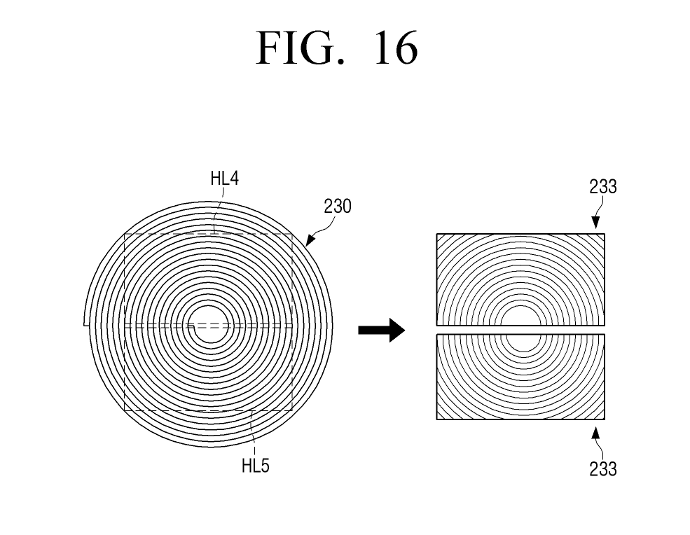

The film member 230 is cut along dashed lines HL4 and HL5 illustrated in FIG. 16 so that the film member has a width that corresponds to the size of the reflection-type screen 30a to laminate the film member on the reflection layer 231 of the reflection-type screen 230, and thus the light absorbing film 233 having a predetermined size can be obtained.

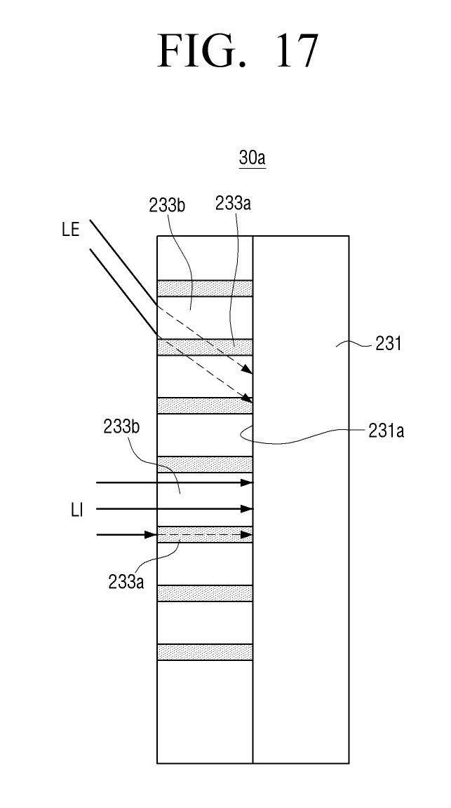

Referring to FIG. 17, the light absorbing film 233 has a plurality of tinted portions 233a and a plurality of light transmission portion 233b that are alternately arranged. The reflection-type screen 30a that is obtained by attaching the light absorbing film 233 to the reflection layer 231 may be used for a long-length reflection-type screen.

As described above, since the reflection-type screen 30a according to the third exemplary embodiment includes the light absorbing film 233, as shown in FIG. 17, the external light LE emitted from the upper side and the left and right sides of the reflection-type screen 30a is absorbed in the tinted portion 233a of the light absorbing film 233 at least once before reaching the reflection layer 231.

In this case, a part of an image light LI that is incident at substantially right angles to the reflection-type screen 30a is incident on the reflection layer 231 after passing through the tinted portion 233a, and the remainder directly passes through the light transmission portion 233b without passing through the tinted portion 233a.

As described above, according to the first to third exemplary embodiments, the light absorbing films 33 and 133 (first and second exemplary embodiments) that are applied to the short-length or ultimate-short-length reflection-type screen 30 or the light absorbing film 233 (third exemplary embodiment) that is applied to the long-length reflection-type screen 30a can be manufactured along the direction in which the film roll is sliced.

While exemplary embodiments have been shown and described, it will be understood by those skilled in the art that various changes in form and detail may be made therein without departing from the spirit and scope of the present disclosure, as defined by the appended claims.

What is claimed is:

1. A method, for manufacturing a light absorbing film, the method comprising:
forming a dye layer by spreading dye including a light absorbing material on a surface of a first transparent film;
laminating a second transparent film on the dye layer;
forming a cylindrical film roll by winding the first transparent film and the second transparent film, laminated on the dye layer, around a core; and
forming a film member by slicing the film roll along a direction that is inclined with respect to a radial direction of the film roll.

2. The method for manufacturing a light absorbing film as claimed in claim 1, wherein the core has a cylindrical shape.

3. The method for manufacturing a light absorbing film as claimed in claim 2, wherein a start position of the slicing the film roll is a chord that passes through a center of a cross-sectional surface of the film roll.

4. The method for manufacturing a light absorbing film as claimed in claim 3, further comprising cutting the film member into a shape that corresponds to a shape of a reflection-type screen.

5. The method for manufacturing a light absorbing film as claimed in claim 4, wherein a side of the film member corresponding to the start position of the slicing corresponds to a lower end of the screen.

6. The method for manufacturing a light absorbing film as claimed in claim 1, wherein the core is an elliptic cylinder.

7. The method for manufacturing a light absorbing film as claimed in claim 6, wherein a start position of the slicing the film roll is a long axis of one cross-sectional surface of the film roll.

8. The method for manufacturing a light absorbing film as claimed in claim 7, further comprising cutting the film member into a shape that corresponds to a shape of a reflection-type screen.

9. The method for manufacturing a light absorbing film as claimed in claim 1, wherein the film member comprises a plurality of tint portions and a plurality of light transmission portions that are inclined with respect to a thickness direction of the film member.

10. The method for manufacturing a light absorbing film as claimed in claim 9, wherein the plurality of tint portions and the plurality of light transmission portions are alternately laminated.

11. The method for manufacturing a light absorbing film as claimed in claim 10, wherein the plurality of tint portions and the plurality of light transmission portions are arranged in a concentric pattern along a surface direction of the light absorbing film.

12. The method for manufacturing a light absorbing film as claimed in claim 1, wherein the dye has a concentration with a predetermined transmission rate.

13. The method for manufacturing a light absorbing film as claimed in claim 1, wherein the dye is black.

14. A light-absorbing film comprising:
a plurality of tinted portions inclined with respect to a thickness direction of the light-absorbing film; and
a plurality of light transmission portions alternately laminated between the plurality of tinted portions,
wherein the plurality of tinted portions and the plurality of light transmission portions are arranged in a concentric pattern along a surface direction of the light-absorbing film.

15. A reflection-type screen comprising:
a light absorbing film as described in claim 14; and
a reflection layer having a front surface to which the light absorbing film is attached.

16. A method of manufacturing a reflection-type screen having a light-absorbing film, the method comprising:
forming the light-absorbing film, comprising:
forming a dye layer by spreading dye, including a light absorbing material, on a surface of a first transparent film;
laminating a second transparent film on the dye layer;
forming a cylindrical film roll by winding the first transparent film and the second transparent film, laminated on the dye layer, around a core; and
forming a film member by slicing the film roll along a direction that is inclined with respect to a radial direction of the film roll; and
cutting the film member into a shape that corresponds to a shape of a reflection-type screen;
affixing the film member to the reflection-type screen, such that a portion of the film member corresponding to a start position of the slicing is affixed to a bottom of the reflection-type screen.
